(19) United States
(12) Patent Application Publication
(10) Pub. No.: US 2010/0269707 A1
(43) Pub. Date: Oct. 28, 2010

(54) POST-MIX BEVERAGE DISPENSER WITH COOLER

(76) Inventors: Klaus Wiemer, Muelheim (DE); Heinz Altenbach, Leverkusen (DE)

Correspondence Address: PYLE & PIONTEK LLC, 221 N. LASALLE STREET, SUITE 1207, CHICAGO, IL, 60601, US

(21) Appl. No.: 12/735,357

(22) PCT Filed: Jan. 8, 2008
(86) PCT No.: PCT/GB2008/000029

§ 371 Date: Jul. 8, 2010

(51) Int. Cl. B01F 3/04; B67D 7/80

(52) U.S. Cl. 99/323.1; 222/146.6

(57) ABSTRACT

A beverage dispense system for a post-mix beverage dispenser in which the concentrate lines 5 are passed through a cooling module 33 within the dispenser. The cooling module 33 has a chamber 33a that is flooded with coolant for heat exchange with the concentrate. The coolant is circulated in a line 21 between a remote cooler 15 and the cooling module 33 within an insulated sheath 19. Diluent is circulated in a line 9 between the cooler 15 and the beverage dispenser for mixing with the concentrate. In a modification, the coolant may comprise diluent for mixing with the concentrate. The concentrate lines 5 do not pass through the insulated sheath 19.

This invention relates to beverage dispense and has particular, but not exclusive, application to the field of soft drinks which are typically dispensed chilled. More especially, the invention concerns the dispense of post-mix beverages such as colas and flavoured sodas in which a concentrate such as a syrup or flavour is mixed with a diluent, typically still or carbonated water, at the point of dispense.

The concentrate and diluent are typically mixed in the correct proportions in a post-mix dispense valve for dispense of the beverage at a dispense outlet of a counter top fitting such as a dispense tower. The tower may have multiple outlets for the dispense of the same or different beverages.

Usually the beverage ingredients are delivered to the tower in separate supply lines from remote sources of the ingredients. Typically, the diluent supply lines pass through a cooler for dispense of chilled beverages. The cooler is often positioned well away from the serving area and the diluent lines are contained in an insulated sheath to prevent the diluent warming up between the cooler and the tower. The concentrate lines are also contained in the insulated sheath and may be passed through the cooler.

Chilled post-mix soft drinks such as colas and flavoured sodas are typically dispensed by mixing a diluent with a concentrate in a ratio of approximately 5:1. Dispense of a drink having a temperature of about 4 to 5° C. can be achieved if the diluent temperature is about 2° C. and the concentrate temperature is about 14° C. Accurate control of the diluent temperature in particular is desirable to maintain the required temperature and this can be a problem during periods of high cooling demand when several drinks are dispensed one after another.

For this reason, many dispense systems are designed to meet these requirements which in practice may only occur for a limited period of time each day. As a result, for a large part of each day when the cooling demand is low, the system is operating under conditions that are not required to meet the cooling demand. This is inefficient, is wasteful of energy and adds to operating costs. As energy costs rise and the environmental effects of inefficient use of energy increase, there is a need for the design of beverage dispense systems that are more efficient and make better use of available energy.

The present invention seeks to provide a system for dispensing beverages, particularly soft drinks and more especially post-mix soft drinks.

It is a preferred object of the invention to provide such a system that can provide one or more benefits and advantages from reduced energy consumption, simplified installation, less syrup waste and easier sanitisation.

According to a first aspect of the invention, there is provided a beverage dispense system as defined in claim 1.

Preferably, the cooling module is located within the dispense unit.

Preferably, a pump is provided for pumping coolant around the re-circulation line and a motor for the pump is operable to control pump speed in response to the coolant temperature in the coolant re-circulation line.

Preferably, the chamber includes an inlet and an outlet connected to the coolant re-circulation line and a flow guide for directing flow of water through the chamber between the inlet and the outlet to optimise heat exchange with concentrate in the concentrate line.

In one embodiment, the coolant is a diluent such as water and the dispense unit includes a post-mix dispense valve connected to the concentrate line and to the coolant re-circulation line.

Preferably, the coolant re-circulation line is connected to a source of still water and includes a carbonator for carbonating the water supplied to the post-mix valve.

Preferably, the cooler comprises a bath of coolant, the carbonator being located within the bath and the water re-circulation line includes a cooling coil within the bath for return flow to the carbonator.

In another embodiment, the dispense unit includes a post-mix dispense valve connected to the concentrate line and to a further re-circulation line extending between the cooler and the dispense unit within the insulated sheath for circulating a diluent such as water.

Preferably, both re-circulation lines are connected to a common water supply and the diluent re-circulation line includes a carbonator for carbonating the water supplied to the post-mix valve.

Preferably, the cooler comprises a bath of coolant, the carbonator being located within the bath and the diluent re-circulation line includes a cooling coil within the bath for return flow to the carbonator.

In one arrangement, the diluent re-circulation line passes through the cooling module.

In another arrangement, the diluent re-circulation line by-passes the cooling module.

Preferably, a pump is provided for pumping diluent around the diluent re-circulation line and a motor for the pump is operable to control pump speed in response to the diluent temperature in the diluent re-circulation line.

Preferably, the cooler includes an evaporator coil within the bath, and an agitator for circulating coolant in the bath, wherein a clearance gap is provided between the evaporator coil and a wall of the bath to permit coolant to circulate on both sides of the evaporator coil.

Preferably, a motor for the agitator is operable to control agitator speed in response to coolant temperature in the bath.

According to a second aspect of the invention, there is provided a method of dispensing a post-mix beverage as defined in claim 16.

In one embodiment, the coolant is a diluent such as water and both the coolant re-circulation line and concentrate line are connected to a post-mix dispense valve of the beverage dispenser.

In another embodiment, a further re-circulation line is provided that extends between the cooler and the beverage dispenser within the insulated sheath for circulating a diluent such as water and both the further re-circulation line and concentrate line are connected to a post-mix dispense valve of the beverage dispenser. In this embodiment, the coolant re-circulation line may be connected to the post-mix dispense valve wherein one of the coolant and diluent re-circulation lines circulates still water and the other circulates carbonated water.

According to a third aspect of the invention, there is provided a beverage dispense system employing a cooling circuit in which a cooling fluid is circulated, a temperature sensor for monitoring the temperature of the cooling fluid and a pump for circulating the cooling fluid in the circuit wherein the pump speed is controlled in response to the temperature of the cooling fluid.

By controlling the pump speed in response to the temperature of the cooling fluid, the circulation of the cooling fluid can be higher during periods of high cooling demand than during periods of low cooling demand thereby reducing power consumption during periods of low cooling demand.

The cooling circuit may provide cooling for one or more product lines. In a system for dispensing post-mix beverages, the product lines may contain a concentrate such as a syrup or flavour for mixing with a diluent such as still or carbonated water to produce a desired beverage. In this arrangement, the cooling circuit may form part of the dispense circuit and contain diluent for mixing with concentrate that has been cooled by the diluent prior to dispense. Alternatively, the cooling circuit may be separate from the dispense circuit and contain a coolant for cooling both the concentrate and diluent.

According to a fourth aspect of the invention, there is provided a method of controlling circulation of fluid in a cooling circuit for a beverage dispense system in response to the temperature of the fluid whereby the circulation of cooling fluid is increased in response to an increase in cooling demand.

The cooling fluid may be a diluent such as still or carbonated water for a post-mix beverage in which the diluent is mixed with a concentrate such as a syrup or flavour that has been cooled by the diluent prior to dispense.

According to a fifth aspect of the invention, there is provided a beverage dispense system for a post-mix beverage comprising a post-mix dispense valve connected to sources of a diluent and a concentrate, wherein a supply line for the concentrate passes through a cooling chamber adjacent to the dispense valve.

By cooling the concentrate adjacent to the dispense valve, the source of concentrate can be located close to the dispense valve reducing the length of the concentrate line making replacement of the concentrate source easier, reducing concentrate waste and facilitating cleaning of the concentrate line.

According to a sixth aspect of the invention, there is provided a method of dispensing a post-mix beverage comprising providing a post-mix dispense valve, connecting the dispense valve to sources of a diluent and a concentrate, and cooling the concentrate by passage through a cooling chamber positioned adjacent to the dispense valve.

The diluent may be passed through the cooling chamber to cool the concentrate and the circulation of diluent may be controlled in response to the cooling demand.

According to a seventh aspect of the invention, there is provided an ice bank cooler comprising a bath containing a coolant, an evaporator coil in the bath for cooling the coolant and forming a thermal reserve of frozen coolant on the evaporator coil, and an agitator for agitating coolant in the bath wherein a motor driving the agitator is operable in response to the coolant temperature in the bath.

By controlling the agitator motor in response to coolant temperature in the bath, the circulation of the coolant in the bath can be increased by employing a higher motor speed during periods of high cooling demand than during periods of low cooling demand thereby reducing power consumption during periods of low cooling demand.

According to an eighth aspect of the invention, there is provided a method of controlling agitation of coolant in an ice bank cooler for a beverage dispense system in response to the temperature of the coolant in the cooler whereby the coolant circulation is increased in response to an increase in cooling demand.

According to a ninth aspect of the invention, there is provided an ice bank cooler comprising a bath containing a coolant, an evaporator coil in the bath for cooling the coolant and forming a thermal reserve of frozen coolant on the evaporator coil, and an agitator for agitating coolant in the bath wherein the coil is arranged so that coolant circulated in the cooler by the agitator passes over frozen coolant on both sides of the coil.

By arranging the coil so that circulation of coolant in the cooler occurs over both sides of the coil, the available surface area of the frozen coolant and thus the cooling capacity of the thermal reserve provided by the frozen coolant during periods of high cooling demand is increased.

According to a tenth aspect of the invention, there is provided a method of controlling temperature of coolant in an ice bank cooler for a beverage dispense system by arranging an evaporator coil in the cooler so that coolant circulated in the cooler passes over frozen coolant on both sides of the coil.

According to an eleventh aspect of the invention, there is provided an insulated sheath for a beverage dispense system, the insulated sheath comprising a core having a plurality of fluid lines formed integrally by extrusion and a cover of thermal insulation around the core.

By extruding the core, any number of fluid lines can be provided according to the system requirements and the core can be cut to the required length of the insulated sheath and covered with thermal insulation.

According to a twelfth aspect of the invention, there is provided a method of forming an insulated sheath for a beverage dispense system comprising extruding a core having a plurality of fluid lines and covering the core with thermal insulation material.

According to a thirteenth aspect of the invention, there is provided a beverage dispense system for a post-mix beverage comprising a diluent source, a concentrate source, a post-mix dispense valve, a diluent line for supply of diluent from the diluent source to the post-mix dispense valve, a concentrate line for supply of concentrate from the concentrate source to the post-mix dispense valve, a cooler located distally from the post-mix dispense valve, and a heat exchange unit located proximally to the post-mix dispense valve, wherein the diluent line comprises a re-circulation loop for circulating diluent between the cooler and the post-mix dispense valve, and the concentrate is cooled in the heat exchange unit by heat exchange with diluent in the re-circulation loop.

Other features, benefits and advantages of the invention in each of its aspects will be understood from the description hereinafter of an exemplary embodiment given by way of example only, with reference to the accompanying drawings in which:—

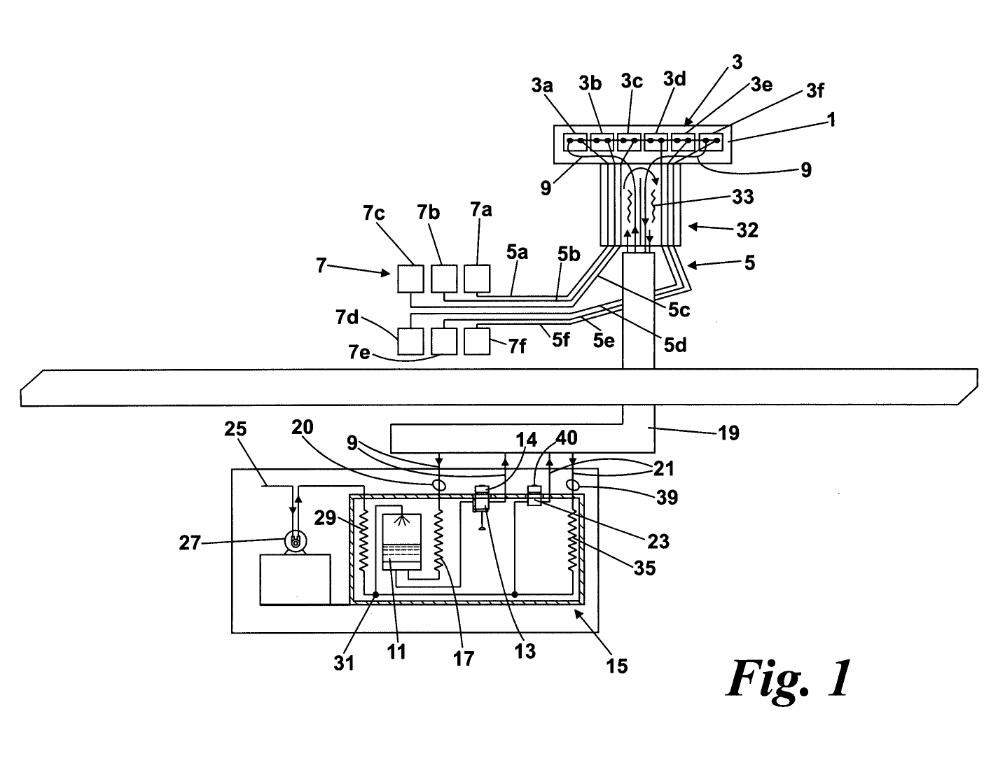

FIG. 1 is a schematic lay-out of a beverage dispense system embodying the invention;

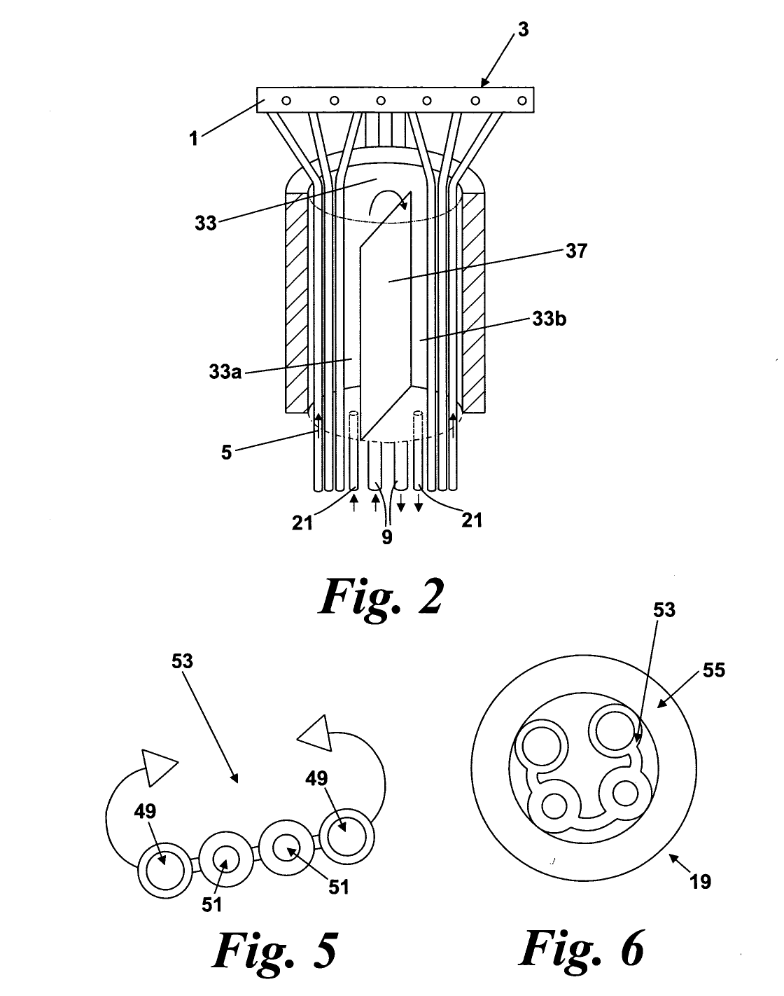

FIG. 2 is a view, to an enlarged scale, showing details of the syrup cooling in the dispense tower of the system shown in FIG. 1;

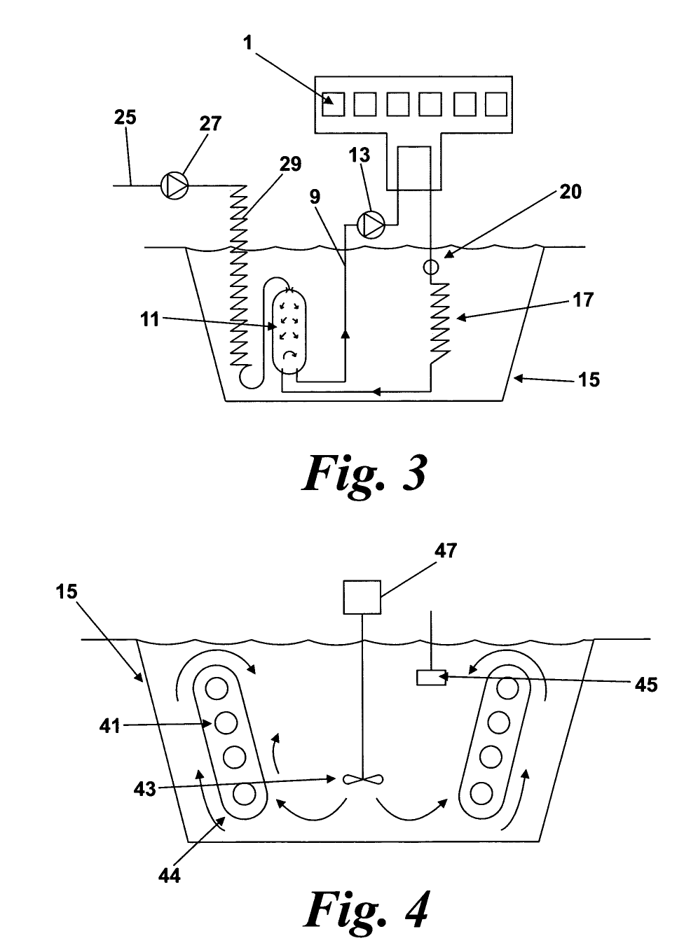

FIG. 3 is a view, to an enlarged scale, showing a modification of the soda re-circulation circuit of the system of FIG. 1;

FIG. 4 is a view, to an enlarged scale, showing details of the cooler for the soda-re-circulation circuit of FIG. 3; and

FIGS. 5 and 6 show details of the insulated sheath shown in FIG. 1.

Referring first to FIG. 1 of the drawings, a post-mix beverage dispense system is shown comprising a manifold valve block 1 provided with a plurality of post-mix dispense valves generally designated by the reference number 3. In this embodiment, the manifold valve block 1 has six dispense valves 3a,3b,3c,3d,3e,3f but it will be understood that the number of dispense valves may be chosen according to requirements.

The dispense valves 3 are connected by individual supply lines generally designated by the reference number 5 to separate supplies of a concentrate generally designated by the reference number 7. In this embodiment, there are six supply lines 5a,5b,5c,5d,5e,5f and six supplies of concentrate 7a,7b,7c,7d,7e,7f—one for each dispense valve 3a,3b,3c,3d,3e,3f. It will be understood, however, that this arrangement is not essential and that the number of supply lines and supplies of concentrate may be varied according to the number of dispense valves and the beverage requirements. For example, two or more dispense valves may be connected to a common supply of concentrate for dispense of the same beverage.

The manifold valve block 1 is also connected to a diluent re-circulation line or loop generally designated by reference number 9 for supplying diluent to each of the dispense valves 3a,3b,3c,3d,3e,3f for mixing with concentrate at the point of dispense to deliver a desired beverage to a container such as a glass, cup or the like placed under an outlet (not shown) of the associated dispense valve 3a,3b,3c,3d,3e,3f. In this embodiment, the re-circulation loop 9 contains carbonated water (often referred to as “soda” water) for dispense of carbonated post-mix beverages from the dispense valves 3. It will be understood, however, that this is not essential and that any other suitable diluent may be employed such as still water for dispense of non-carbonated drinks such as fruit juices.

The dispense valves 3 are configured to mix carbonated water and concentrate in the relative proportions required for the beverage to be dispensed. The relative proportions may vary for different beverages and the valves are configured individually on initial set-up according to the beverage to be dispensed. Such configuration may be carried out manually or automatically. For example, the dispense valves 3 may be controlled by a programmable controller such as a microprocessor that allows the relative proportions of diluent and concentrate to be set on an individual basis at any time by a service engineer. The controller may also control other functions of the dispense system via a suitable user interface for operating the dispense valves 3 according to customer selection of a desired beverage. Alternatively, the dispense valves 3 may be manually operable.

The diluent re-circulation loop 9 includes a carbonator tank 11 and a circulation pump 13 driven by an electric motor 14. The carbonator tank 11 is provided at a location remote from the manifold valve block 1, for example in a storage area such as a cellar or cold room, and in this embodiment, is immersed in a bath of chilled water provided by an ice bank cooler 15. Chilled carbonated water is pumped around the re-circulation loop 9 from the carbonator tank 11 to the manifold valve block 1 and back to the carbonator tank 11. The carbonated water returning to the carbonator tank 11 passes through a cooling coil 17 immersed in the chilled water bath of cooler 15 to cool the carbonated water prior to re-entering the carbonator tank 11.

Between the cooler 15 and the manifold valve block 1, the re-circulation loop 9 is contained in an insulated sheath or sleeve or line 19 and the temperature of the carbonated water returning to the carbonator tank 11 is monitored by a temperature sensor 20 provided before the cooling coil 17 for a purpose described later herein. The insulated sheath 19 reduces heat exchange between the environment externally of the sheath and the carbonated water in the re-circulation loop 9 within the sheath.

The carbonator tank 11 has an inlet connected to a source of still water such as mains water via a supply line 25 for adding still water to the carbonator tank 11 to replace carbonated water that has been dispensed when the water level in the carbonator tank 11 falls to a pre-determined minimum. The upper and lower water levels in the carbonator tank 11 are controlled by level sensors (not shown) that also control operation of a pump 27 in the water supply line 25 to boost the water pressure for addition to the carbonator tank 11 where it is simultaneously carbonated by injecting a supply of carbonating gas into the water stream as it is added to the carbonator tank 11.

The pressure of carbonating gas in the headspace above the water level in the carbonator tank 11 is maintained at a level sufficient to prevent the carbonating gas coming out of solution so that the desired carbonation level of the carbonated water circulating in the carbonated water re-circulation loop 9 is maintained. Typically, the carbonating gas is carbon dioxide but other gases such as nitrogen may be employed and the term “carbonating” gas is to be construed accordingly.

The water supply line 25 passes through a cooling coil 29 immersed in the chilled water bath of the cooler 15 upstream of a T-junction 31 for supply of chilled water to either the carbonating tank 11 or to a coolant re-circulation line or loop 21 according to demand. Cooling the still water before it is added to the carbonator tank 11 assists the carbonation process to achieve the desired carbonation level in the carbonated water for dispense of carbonated beverages from the dispense valves 3.

The coolant re-circulation loop 21 passes from the cooler 15 to a cooling module 32 adjacent to the manifold valve block 1 for cooling concentrate supplied to the manifold valve block 1 in the supply lines 5a,5b,5c,5d,5e,5f. The cooling module 32 has a chamber 33 with an inlet connected to the re-circulation loop 21 to receive chilled water from the cooler 15 and an outlet connected to the re-circulation loop 21 to return the water back to the cooler 15. The return flow of water passes through a cooling coil 35 immersed within the chilled water bath of cooler 15. The water is circulated around the coolant loop 21 by a pump 23. Between the cooler 15 and the coolant chamber 33, the coolant re-circulation loop 21 is contained in the insulated sheath 19 and the temperature of the water returning to the cooler 15 is monitored by a temperature sensor 39 provided before the cooling coil 35 for a purpose described later herein.

The manifold valve block 1 and coolant chamber 33 are contained in a beverage dispenser, for example in a dispense tower (not shown), provided at a location remote from the cooler 15 such as a bar or similar serving area where the tower may be located on a counter top for connection to the various supply lines 5 for the concentrates 7, and the re-circulation loops 9 and 21 for carbonated water and coolant. The re-circulation loop 9 may supply carbonated water to more than one tower 1 in the same or different serving areas. Alternatively or additionally, the carbonator tank 11 may supply carbonated water to separate re-circulation loops 9 for supply to more than one tower. Similarly, the re-circulation loop 21 may supply coolant to more than one tower 1 in the same or different serving areas. Alternatively or additionally, separate re-circulation loops 21 may be provided for supply of coolant to more than one tower. All combinations and configurations are possible according to the number and position of the towers.

Referring now to FIG. 2, the arrangement for cooling the concentrate supplied to the tower 1 is shown in more detail. Most post-mix beverages contain approximately 85% of diluent and 15% of concentrate. In many existing dispense systems the concentrate is cooled by passing the supply lines to the dispense tower in the insulated sheath. This increases the cooling demand in the insulated sheath resulting in an energy consumption to cool the soda in the soda re-circulation loop 9 that is higher than actually required to achieve and maintain the required concentrate temperature. For example, at a dispense rate of 4 drinks per minute, the energy to cool the concentrate (syrup) is 10 kcal. A 20 metre insulated sheath containing six concentrate supply lines contains 10 litres of concentrate and the energy consumption is 10 W/m or 1750 KWh per year.

To reduce the energy consumption for cooling the concentrate, the present invention removes the concentrate lines from the insulated sheath and cools the concentrate in the dispense tower. More specifically, the concentrate is cooled within the tower immediately prior to dispense and the supply lines 5 passing through the coolant chamber 33 contain a significantly lower volume of concentrate that is subjected to cooling compared to existing systems in which the concentrate supply lines are contained in the insulated sheath 19.

As shown, the concentrate supply lines 5a,5b,5c,5d,5e,5f pass through the coolant chamber 33 within the tower to the manifold valve block 1. The chamber 33 is insulated to prevent heat exchange between the coolant in the chamber 33 and the warmer surroundings in the serving area. The carbonated water re-circulation loop 9 by-passes the coolant chamber 33 and is connected to the manifold valve block 1 within the tower 1.

The coolant re-circulation loop 21 is connected to the chamber 33 for circulating chilled still water through the chamber 33 to cool the concentrate delivered in supply lines 5a,b,5c,5d,5e,5f to the dispense valves 3a,3b,3c,3d,3e,3f. The chamber 33 is provided with an internal flow guide 37 that directs the flow of coolant through the chamber 33 to optimise heat exchange with the concentrate supply lines 5a,5b,5c,5d,5e,5f passing through the chamber 33.

In this embodiment, the flow guide 37 comprises a partition wall that divides the chamber 33 into an inlet chamber 33a and an outlet chamber 33b. Coolant from the re-circulation loop 21 enters the inlet chamber 33a at the lower end of the coolant chamber 33. The coolant is confined by the flow guide 37 to flow upwards to the upper end of the coolant chamber 33 where it flows across the partition wall into the outlet chamber 33b. The coolant is confined by the flow guide 37 to flow downwards to the lower end of the coolant chamber 33 where it exits the coolant chamber and returns to the re-circulation loop 21.

In this embodiment, three of the concentrate supply lines pass through the inlet chamber 33a and the other three concentrate supply lines pass through the outlet chamber 33b. It will be understood, however that other arrangements of the concentrate supply lines 5 may be employed as desired. For example, while the lines are shown extending linearly through the coolant chamber 33, this is not essential and other configurations of the concentrate lines within the coolant chamber 33 may be employed such as coils to increase the surface area available for heat transfer to achieve the desired cooling of the concentrate. Furthermore, it will be understood that other configurations of coolant chamber 33 may be employed to direct the flow of coolant over the concentrate supply lines 5 to achieve the desired cooling of the concentrate.

As will be appreciated, the above arrangement reduces the length of the concentrate supply lines 5a,5b,5c,5d,5e,5f which reduces syrup wastage and makes sanitisation of the lines easier. Also, the concentrate sources can be sited close to the dispense tower, for example on a shelf under the counter top in the serving area, which simplifies replacement of the concentrate sources.

Typically, the concentrate and diluent are mixed in a ratio approximately of 1:5 and a temperature of approximately 4 to 5° C. in the dispensed beverage can be achieved with a concentrate temperature of around 14° C. where the diluent temperature is about 2° C. Passage of the concentrate supply lines 5 through the cooling chamber 33 is generally sufficient to achieve the necessary cooling of the concentrate without passing the concentrate lines 5 through the insulated sheath 19 or the cooler 15.

The syrup cooling requirement in the cooling chamber 33 is dependent on a number of factors including the ambient temperature and beverage dispense while heat gain in the carbonated water circuit is dependent on a number of factors including the ambient temperature, the insulated sheath (length, insulation, number of tubes etc) and beverage dispense.

Existing beverage dispense systems are typically designed to meet the higher cooling demand that arises during periods when beverages are being dispensed (dispense mode) than in periods when no beverages are being dispensed (stand-by mode). Many dispense systems, however, are only operable in the dispense mode for about 20% of the day (less than 4 hours) and for the remaining 80% of the day (more than 20 hours) the system is in the stand-by mode. As a result, designing the system to meet the cooling demand in the dispense mode leads to a significant waste of energy in the stand-by mode.

To reduce this heat gain, the present invention provides temperature sensors 20 and 39 to monitor the temperature of the return flows of carbonated water in the diluent re-circulation loop 9 from the manifold valve block 1 to the carbonator tank 11 and of still water in the coolant re-circulation loop 21 from the cooling chamber 33 to the cooler 15. The temperatures detected by the sensors 20,39 are used to control operation of the re-circulation pumps 13,23 respectively. In this embodiment both pumps 13,23 are twin-speed pumps driven by electric motors 14,40 respectively that are switched from low speed, for example 800 rpm, to high speed, for example 1400 rpm, when the temperature of detected by the associated sensor 20,39 rises above a pre-set temperature, for example 2° C. for the carbonated water and 2° C. for the still water. It will be understood, however, that other motor speeds and/or temperatures may be employed to take account of factors such as the cooling requirement, and other design parameters of the system.

More specifically, the system is designed so that, in periods of low cooling demand when the temperatures of the carbonated water and still water in the re-circulation loops 9,21 are below the pre-set temperatures such as in the stand-by mode or in periods of low dispense, the re-circulation pumps 13,23 are switched to the low speed to reduce energy consumption and, in periods of high cooling demand, if the temperatures of the carbonated water or still water in the re-circulation loops 9,21 rise above the pre-set temperatures, such as in the dispense mode or at higher ambient temperatures, the associated re-circulation pump 13,23 is switched to the high speed to meet the increased cooling demand. In this way, operation of the re-circulation pumps 13,23 is more energy efficient leading to cost savings.

It will be understood that the pumps 13,23 may be a twin-speed pumps for selection of high or low speeds as described or one or both pumps may be a variable speed pump such that the pump speed can be adjusted to provide high and low speeds and any intermediate speeds as desired. Where a variable pump speed is permitted, this may be controlled by a suitably programmed microprocessor or other control system responsive to the temperature detected by the sensors 20,39.

In a modification (not shown), the coolant re-circulation loop 21 is also connected to the manifold valve block 1 which can be designed so that each dispense valve can selectively dispense a mixture of concentrate and either carbonated water from re-circulation loop 9 or still water from re-circulation loop 21 or a mixture of both carbonated water and still water. In this way, carbonated drinks, or still drinks or drinks with a variable carbonation level can be dispensed. Alternatively, the manifold valve block 1 may be designed so that one or more dispense valves can dispense the carbonated water and the or each of the remaining dispense valves can dispense the still water. In another modification (not shown), one or more dispense valves may be configured to dispense diluent only, for example to dispense still or carbonated water without any concentrate. Other arrangements that can be employed will be apparent to those skilled in the art.

Referring now to FIG. 3, a modification of the above-described system is shown in which like reference numerals are used to indicate corresponding parts.

In this modification, the still water re-circulation line or loop 21 in FIG. 1 is omitted and the coolant chamber 33 is connected to the diluent re-circulation line or loop 9. In this way, the chilled carbonated water supplied to the manifold valve block 1 also passes through the coolant chamber 33 to cool the syrup supplied to the manifold valve block 1 in the concentrate supply lines (not shown in FIG. 3 for clarity). In this way, one and the same re-circulation loop can be used extending between the cooler 15 and the manifold valve block 1 within the insulated sheath (not shown) both to supply diluent to the manifold valve block and to cool the concentrate. The operation of this modified system is similar to that of FIG. 1 and will be understood from the description already provided. With this arrangement, the system only dispenses carbonated drinks. It will be understood, that the system of FIG. 1 could be adapted so as to dispense only still drinks by omitting the carbonated water re-circulation loop 9 in FIG. 1 and connecting the still water loop 21 to the manifold valve block 1.

Referring now to FIG. 4, the arrangement of the ice bank cooler 15 is shown in more detail. Known ice bank coolers typically comprise a bath containing water that is cooled by placing an evaporator of a refrigeration circuit in the bath so that ice forms on the evaporator during periods of low cooling demand to provide a thermal reserve for periods of high cooling demand during which the ice melts to provide additional cooling. A sub-zero ice bank may be produced by the use of an additive that suppresses the freezing point of water. For example an aqueous mixture of water with glycol, a salt, antifreeze or other suitable material added to the water in the bath.

Usually, the evaporator is situated close to the side wall of the bath and the water in the bath is circulated by an agitator driven by an electric motor to wash across the surface of the ice bank on the inwardly facing side of the evaporator to melt the ice during periods of high demand. Washing across one side of the ice bank reduces the available surface area for cooling during periods of high demand which reduces efficiency.

Also many systems employ an agitator and motor combination that is designed to circulate the water to meet the cooling requirement during periods of high cooling demand. As previously mentioned, this is wasteful of energy as the high cooling demand mainly arises during the dispense mode which is only in operation for about 20% of the day with the remainder being the stand-by mode when the cooling demand is much lower.

To improve cooling efficiency, the present invention provides the ice bank cooler 15 with an evaporator coil 41 spaced away from the side wall of the bath so that water circulated by the agitator 43 washes across both sides of the coil 41 as shown by the arrows thereby doubling the available surface area of the ice bank 44 that forms on the coil 41 for the additional cooling required during periods of high demand.

To obtain the benefit of the larger available surface area of the ice bank 44, the circulation of the water within the bath requires improved performance of the agitator 43. As a result, more power is required to operate the agitator 43 during periods of high demand and the present invention employs a temperature sensor 45 to monitor the temperature of the water in the bath and control operation of a motor 47 driving the agitator 43 in response to the water temperature.

In this embodiment, the motor 47 is a twin-speed motor that is switched from low speed, for example 1500 rpm, to high speed, for example 3000 rpm, when the temperature of the water detected by the sensor 45 rises above a pre-set temperature, for example 1° C. It will be understood, however, that other motor speeds may be employed to take account of factors such as the cooling requirement, the capacity of the cooler and other design parameters of the system.

In this way, in periods of low cooling demand when the temperature of the water in the water bath is below the pre-set temperature such as in the stand-by mode or in periods of low dispense, the motor 47 is switched to the low speed to reduce energy consumption and, in periods of high cooling demand when the temperature of the water in the water bath circuit rises above the pre-set temperature such as in the dispense mode, the motor 45 is switched to the high speed to operate the agitator 43 to meet the increased cooling demand. In this way, operation of the agitator and motor combination is more energy efficient leading to cost savings.

It will be understood that the agitator 43 may be driven with a twin-speed motor for selection of high or low agitation speeds as described or a variable speed motor may be employed such that the agitator speed can be adjusted to provide high and low speeds and any intermediate speeds as desired. Where a variable agitator speed is permitted, this may be controlled by a suitably programmed microprocessor or other control system responsive to the temperature detected by the temperature sensor 45.

Referring now to FIGS. 5 and 6, there is shown an alternative insulated sheath design according to the present invention. In the traditional insulated sheath design, the diluent lines, concentrate lines and coolant lines are bundled together within the insulated sheath. The diameter of the insulated sheath is dependent on the number and size of individual lines that are wrapped within the sheath. The diameter of the insulated sheath increases with increased number of lines with the result that construction, handling and installation of the insulated sheath becomes more difficult and the available surface area of the insulated sheath for heat transfer from ambient increases.

The present invention simplifies the insulated sheath construction by removing the concentrate lines through the provision of cooling for the concentrate in the dispense tower and forming lines 49,51 for the diluent and coolant respectively as a single extrusion 53 that can be cut to the required length, formed into an annular configuration as shown by the arrows, surrounded with insulation 55 and provided with quick-fit connectors (not shown) at both ends for attaching the diluent and coolant lines 49 and 51 respectively to matching connectors on the cooler 15 and the dispense tower.

In this way, insulated sheaths having any desired length can be made from a common extrusion and provided with the appropriate fluid connections at each end for connection to matching connectors on the cooler 15 and dispense tower 1 when the insulated sheath is installed. This is easier than bundling several separate fluid lines together within an insulation sheath. Also, the overall diameter of the insulated sheath can be reduced thereby reducing the weight of the insulated sheath making handling and installation easier and reducing the surface area for heat exchange with the environment. Alternatively or additionally, the insulated sheath can have insulation of increased thickness to reduce heat exchange with the environment without increasing the overall diameter of the insulated sheath compared to existing insulated sheath designs.

As will be appreciated, the above-described system has a number of advantages and benefits. For example lower energy consumption by reducing the heat gain and controlling the speed of the motors driving the re-circulation pumps and agitator in response to the temperature of the water in the re-circulation loops and water bath respectively. Also easier sanitisation of the concentrate lines and less wastage of concentrate in the concentrate lines can be achieved by removing the concentrate lines from the insulated sheath and providing shorter concentrate lines from the concentrate sources to the dispense tower. This also allows easier replacement of the concentrate sources by enabling the concentrate sources to be placed below the dispense tower within the serving area. Also reduced installation time may be possible by the use of a customised insulated sheath that can be connected to the diluent and coolant lines by multi-port block connectors during installation.

It will be understood that the invention is not limited to the embodiments above-described which are intended to illustrate the various benefits and advantages of the invention. Moreover, it will be understood that any of the features of the embodiments above-described may be employed separately or in combination with any other feature in a beverage dispense system.

Furthermore, while the invention has been described with particular reference to the dispense of soft drinks, it will be understood that the invention is not limited to such application and the invention could be employed for the dispense of alcoholic drinks such as cocktails while features of the invention could be employed in systems for the dispense of alcoholic drinks. For example, the ice bank cooler could be used to cool beer, lager, cider and the like for dispense.

1. A beverage dispense system for a post-mix beverage comprising a beverage dispense unit at a first location, a cooler at a second location remote from said dispense unit, a cooling module at said first location, a coolant re-circulation line extending between said cooler and said cooling module within an insulated sheath extending from or near said cooler to or near said dispense unit, a concentrate source at said first location, a concentrate line extending between said concentrate source and said dispense unit without passing through said insulated sheath, wherein said cooling module comprises a chamber through which said concentrate line passes and said chamber is connected to said coolant re-circulation line for passing coolant through said chamber to transfer heat from said concentrate to said coolant for cooling said concentrate.

2. A beverage dispense system according to claim 1, wherein said cooling module is located within said dispense unit.

3. A beverage dispense system according to claim 1, wherein a pump is provided for pumping coolant around said re-circulation line and a motor for said pump is operable to control pump speed in response to coolant temperature in said coolant re-circulation line.

4. A beverage dispense system according to claim 1 wherein said chamber includes an inlet and an outlet connected to said coolant re-circulation line and a flow guide for directing flow of water through said chamber between said inlet and said outlet to optimise heat exchange with concentrate in said concentrate line.

5. A beverage dispense system according to claim 1 wherein said coolant is water and said dispense unit includes a post-mix dispense valve connected to said concentrate line and to said coolant re-circulation line.

6. A beverage dispense system according to claim 5 wherein said coolant re-circulation line is connected to a source of still water and includes a carbonator for carbonating water supplied to said post-mix valve.

7. A beverage dispense system according to claim 6 wherein said cooler comprises a bath of coolant, said carbonator being located within said bath and said water re-circulation line includes a cooling coil within said bath for return flow to said carbonator.

8. A beverage dispense system according to claim 1 wherein said dispense unit includes a post-mix dispense valve connected to said concentrate line and to a diluent re-circulation line extending between said cooler and said dispense unit within said insulated sheath.

9. A beverage dispense system according to claim 8 wherein both re-circulation lines are connected to a common water supply and said diluent re-circulation line includes a carbonator for carbonating water supplied to said post-mix valve.

10. A beverage dispense system according to claim 9 wherein said cooler comprises a bath of coolant, said carbonator being located within said bath and said diluent re-circulation line includes a cooling coil within said bath for return flow to said carbonator.

11. A beverage dispense system according to claim 10 wherein said diluent re-circulation line passes through said cooling module.

12. A beverage dispense system according to claim 10 wherein said diluent re-circulation line by-passes said cooling module.

13. A beverage dispense system according to claim 8 wherein a pump is provided for pumping diluent around said diluent re-circulation line and a motor for said pump is operable to control pump speed in response to diluent temperature in said diluent re-circulation line.

14. A beverage dispense system according to claim 7, wherein said cooler includes an evaporator coil within said bath, and an agitator for circulating coolant in said bath, wherein a clearance gap is provided between said evaporator coil and a wall of said bath to permit coolant to circulate on both sides of said evaporator coil.

15. A beverage dispense system according to claim 14, wherein a motor for said agitator is operable to control agitator speed in response to coolant temperature in said bath.

16. A method of dispensing a post-mix beverage comprising providing a post-mix beverage dispenser at a first location, providing a cooler at a second location remote from the beverage dispenser, providing a cooling module at the first location, providing a coolant re-circulation line extending between the cooler and the cooling module within an insulated sheath extending between the first and second locations, connecting the coolant re-circulation line to a chamber of the cooling module, providing a concentrate source at the first location, connecting a concentrate line from the concentrate source to the beverage dispenser without passing through the insulated sheath, and passing said concentrate line through the chamber for cooling the concentrate by heat exchange with coolant in the chamber.

17. A method according to claim 16 wherein the coolant is water and both the coolant re-circulation line and concentrate line are connected to a post-mix dispense valve of the beverage dispenser.

18. A method according to claim 16 wherein a diluent re-circulation line extends between the cooler and the beverage dispenser within the insulated sheath and both the diluent re-circulation line and concentrate line are connected to a post-mix dispense valve of the beverage dispenser.

19. A beverage dispense system according to claim 10, wherein the cooler includes an evaporator coil within the bath, and an agitator for circulating coolant in the bath, wherein a clearance gap is provided between the evaporator coil and a wall of the bath to permit coolant to circulate on both sides of the evaporator coil.

20. A beverage dispense system according to claim 19, wherein a motor for the agitator is operable to control agitator speed in response to coolant temperature in the bath.
